(19) United States
(12) Patent Application Publication
(10) Pub. No.: US 2006/0042424 A1
(43) Pub. Date: Mar. 2, 2006

(54) Fastener tool with adjustable jaws

(76) Inventor: Alex Parsa Pirseyedi, West Vancouver (CA)

Correspondence Address: John Russell Uren, P. Eng., Suite 202, 1590 Bellevue Avenue, West Vancouver, BC, V7V 1A7, CA

(21) Appl. No.: 10/926,274

(22) Filed: Aug. 24, 2004

(51) Int. Cl. B25B 13/12; B25B 13/16

(52) U.S. Cl. 81/163; 81/129; 81/155

(57) ABSTRACT

A tool with adjustable jaws for rotating a fastener. The jaws are located within a housing which shares the torque load applied to the fastener through the jaws. An adjustment mechanism moves the jaws laterally within the housing on an adjustment shaft which is rotated through an accessible adjusting wheel. The adjustment shaft has a groove formed therein and a ball within the grooves. There is relative movement between the ball and the groove for jaw adjustment.

This invention relates to a tool with adjustable jaws for installing and removing fasteners such as bolts and screws and, more particularly, to a tool with adjustable jaws that is in the form of a socket allowing significant tool integrity and in which tool jaw adjustment is facilitated.

### BACKGROUND OF THE INVENTION

Adjustable socket wrenches are, of course, well known in the trade. Le Duc U.S. Pat. No. 4,864,901, Carnesi U.S. Pat. No. 6,073,522, Roder U.S. Pat. No. 4,136,555, Kolari et al U.S. Pat. No. 4,967,625, McClure U.S. Pat. No. 5,375,489 and Voskanyan U.S. Pat. No. 6,662,689 teach such representative prior art. However, there are disadvantages inherent in such prior art sockets. The aforementioned le Duc, Carnesi, Roder, Kolari et al and Voskanyan references teach a non-integral housing or a housing of limited dimensions which housing fails to encompass the circumference of the fastener grasping jaws during operation. Thus, substantial torque transfer to the housing does not result which adversely affects tool integrity during operation. A further disadvantage of prior art is that jaw adjustment is tedious and play in the jaws occurs with the adjustment mechanisms there described. Yet a further disadvantage of the prior art is that the jaws move outside of the housing during operation. Changing the external shape of the tool may require more space. It is desirable to maintain the external dimensions of the socket under use because tool space may be at a premium.

### SUMMARY OF THE INVENTION

According to one aspect of the invention, there is provided an adjustable tool used to grasp and loosen or tighten a fastener, said tool comprising a set of jaws, at least one of said jaws being movable on an axis transverse to said axis of said fastener to be tightened or loosened, said jaws defining an opening ranging between fully open and fully closed positions, said movable jaw being located within a housing adjacent to and surrounding the periphery of said jaw, said housing being an integral member and said movable jaw being movable by an adjustment mechanism, said movable jaw operably contacting said housing in a force transfer relationship during said fastener loosening or fastener tightening operation.

According to a further aspect of the invention, there is provided an adjustable tool having a set of jaws operable to grasp a fastener to be removed or installed, said tool having at least one movable jaw within said housing and mounted on a shaft radial to the axis of said fastener, said jaw being positioned within said housing, and an adjusting wheel accessible by a user and being connected to said shaft, said shaft having at least one groove formed therein and at least one ball within said groove which ball is rotatable within said groove.

According to yet a further aspect of the invention, there is provided a method of loosening or tightening a fastener using a set of adjustable jaws, at least one of said jaws being movable within a housing, said method comprising forming an opening between said jaws to operably allow the grasping of said fastener, applying a torque to said jaws to rotate said fastener and transferring a substantial portion of said torque from said jaws to said housing while loosening or tightening said fastener.

According to still yet a further aspect of the invention, there is provided a method of loosening or tightening a fastener using a set of adjustable jaws, at least one of said jaws being movable within a housing, said method comprising forming an opening between said jaws to operably allow the grasping of said fastener by rotating a shaft with a groove formed therein and a ball rotatable within said groove, said rotation of said shaft adjusting said opening of said jaws.

### BRIEF DESCRIPTION OF THE SEVERAL VIEWS OF THE DRAWINGS

Specific embodiments of the invention will now be described, by way of example only, with the use of drawings in which:

FIG. 1 is a diagrammatic isometric and exploded view of the adjustable socket according to the invention;

FIGS. 2A, 2B and 2C are diagrammatic isometric and assembled views of the adjustable socket according to the invention;

FIGS. 3A and 3B are diagrammatic side and bottom views of the adjustable socket according to the invention with the jaws in their maximum open position;

FIG. 3C is a diagrammatic isometric view similar to those of FIGS. 3A and 3B but also illustrating a fastener shown in phantom and being grasped by the jaws of the adjustable socket;

FIGS. 4A and 4B are views similar to those of FIGS. 3A and 3B but illustrate the jaws in their minimum or smallest position;

FIG. 4C is a view similar to FIG. 3C but illustrate the jaws in their minimum or smallest position;

FIGS. 5A and 5B are diagrammatic isometric views of the adjustable socket according to the invention with the jaw adjustment indices shown on the housing and on the adjusting wheel, respectively; and

FIGS. 6A and 6B are diagrammatic isometric views of the adjustable tool illustrating a handle integral with the tool in a further embodiment of the invention.

### DESCRIPTION OF SPECIFIC EMBODIMENT

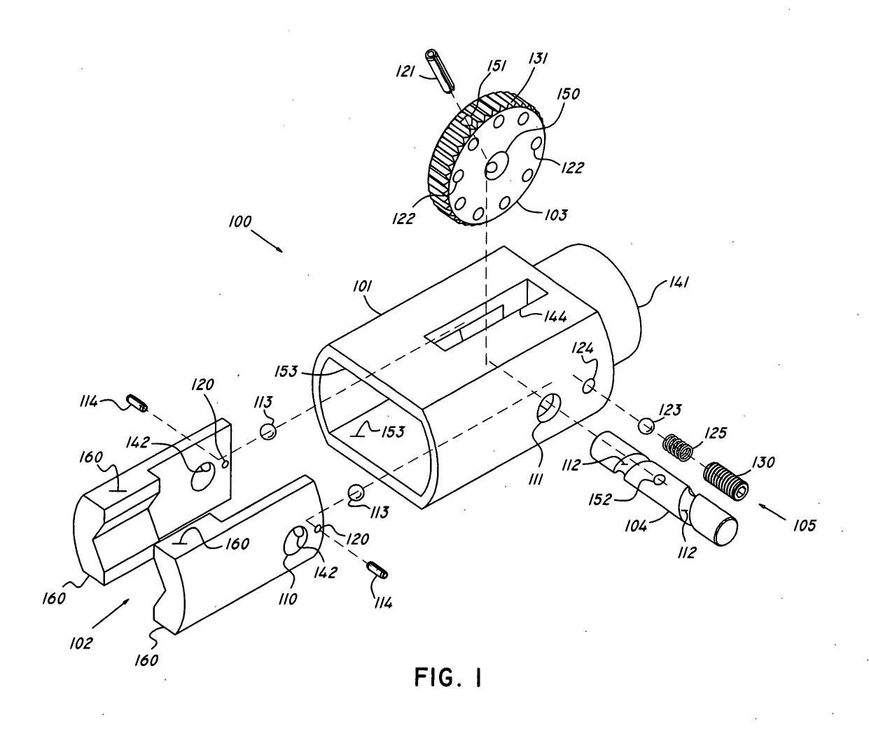

Referring now to the drawings, an adjustable tool or adjustable socket is generally illustrated at 100 in FIG. 1. It comprises four principal components, namely the body or housing 101, a pair of adjustable jaws 102, an adjusting or indexing wheel 103 and an adjustment shaft 104 which is fixed to and rotates with the adjusting wheel 103.

The adjustable jaws 102 fit entirely within the housing 101 and have two radial holes 110 in their inner portion which holes 110 allow the adjustment shaft 104 to pass therethrough. Two further radial holes 111 (only one of which is illustrated in FIG. 1) are provided in housing 101. These holes 111 have an axis which is coincident with the axis of radial holes 110. Two grooves 112 are provided on adjustment shaft 104, one left hand and the other right hand. The grooves 112 have followers in the form of traveling balls 113 which are maintained in position within the grooves 112 by way of retaining pins 114 inserted through complementary holes 120 in each of the respective jaws 102.

The adjusting wheel 103 is mounted on the adjustment shaft 104 and is retained in position on adjustment shaft 104 by way of retaining pin 121.

Adjusting wheel 103 conveniently utilises a detent mechanism generally illustrated at 105 and which includes a plurality of recesses or indentations 122 machined around one of the circumferential faces of the adjusting wheel 103 and which further includes a ball 123, a spring 125 and a set screw 130. The recesses 122 serve as indexing positions to maintain the jaws 102 in predetermined positions as the adjusting wheel 103 is rotated.

Ball 123 is located in housing 101 and is inserted through a complementary hole 124. Spring 125 is positioned outside the ball 123 for providing an inwardly directed force on ball 123 and set screw 130 maintains the ball 123 and spring 125 in position within the housing 101. Ball 123 therefore rolls on the face of the adjusting wheel 103 between the recesses 122 and, when a recess or indentation 122 is reached, the ball 123 will fall partially into the recess 122 and therefore tend to maintain the adjusting wheel 103 and adjustment shaft 104 in their selected position.

Adjusting wheel 103 may conveniently also have grooves 131 about its circumference which grooves allow for easier manual rotation by the finger or hand of a user.

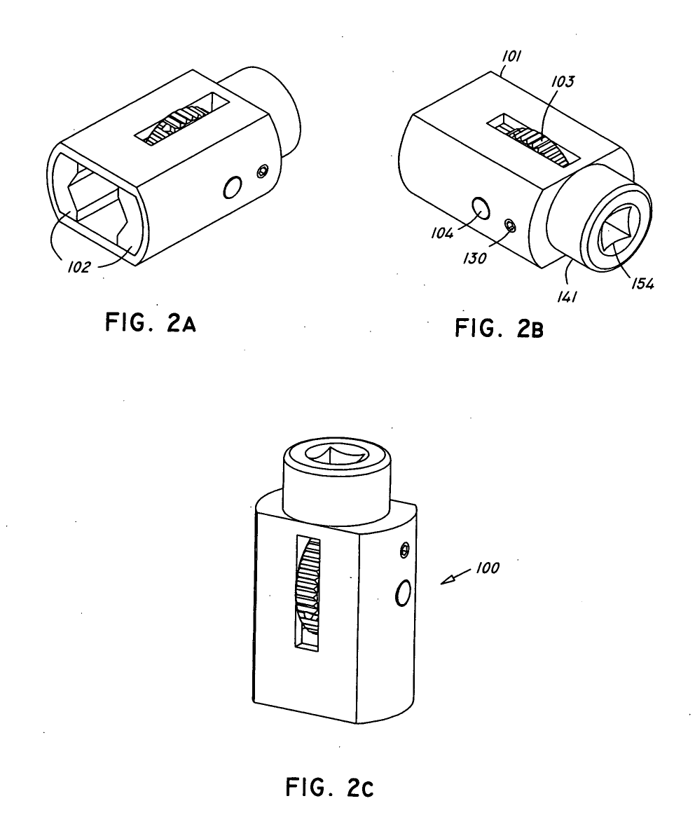

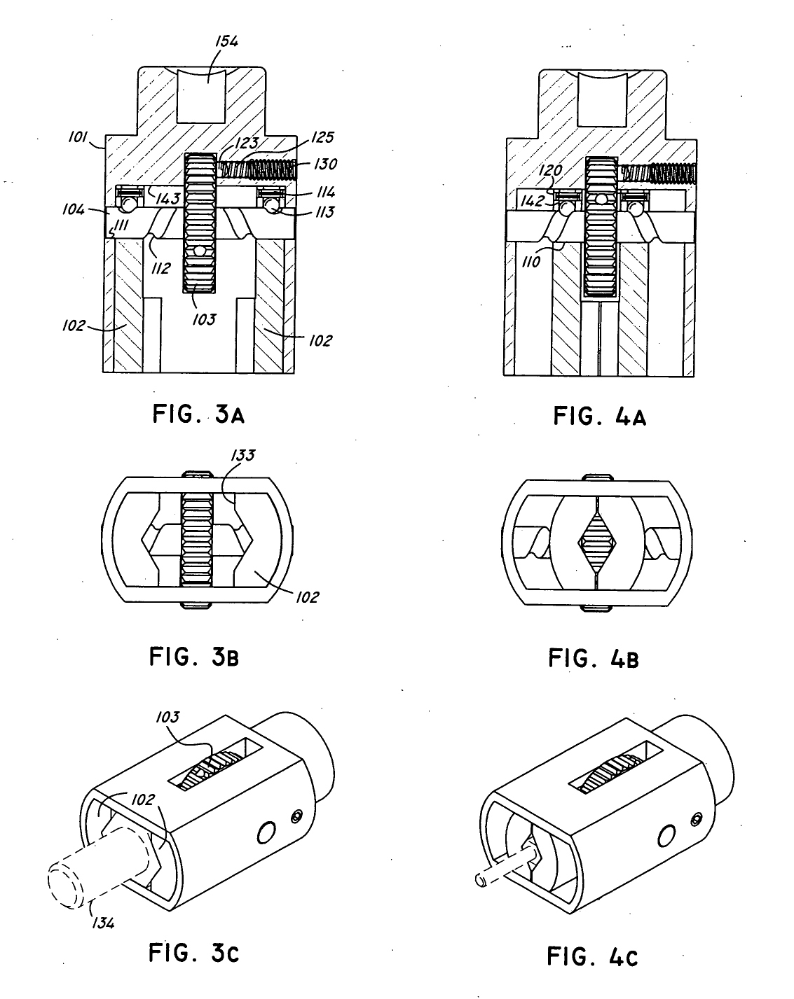

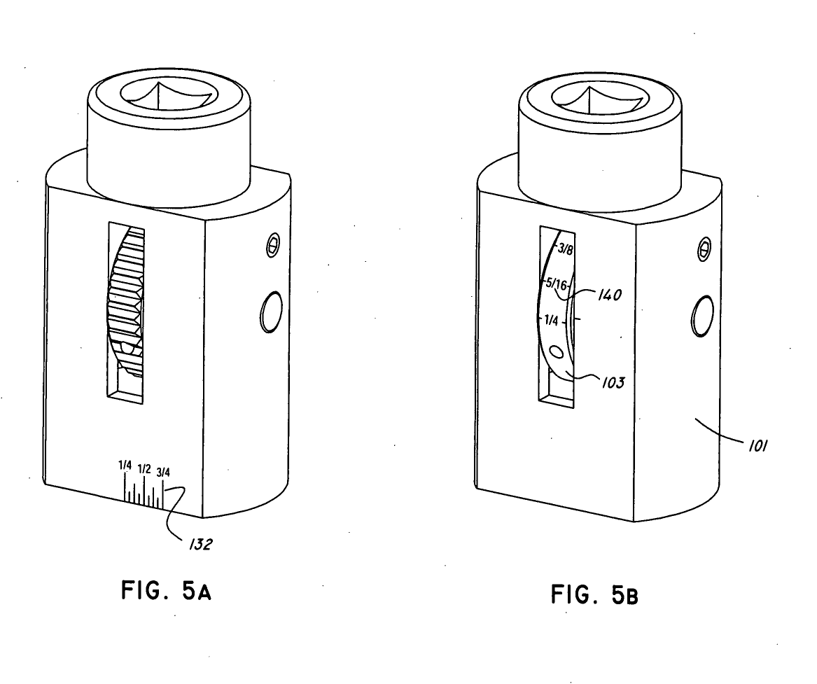

The housing 101 may conveniently include graduations 132 printed thereon as seen in FIG. 5A. In this event, the inside surface 133 of the jaws 102 (FIG. 3B) is referenced against the graduations 132 to indicate to the user the extent of the opening of the jaws 102 such that facilitated cross reference is provided between the opening of the jaws 102 and the size of the fastener 134 (FIG. 3C) intended to be tightened or loosened. Alternatively, indexing 140 can be provided on the adjusting wheel 103 to similarly indicate the opening of the jaws 102 to the user as seen in FIG. 5B. Housing 101 may also conveniently provide a circumferential head 141 which includes a square cavity 154 (FIG. 2B) allowing for the entry of the square drive of a ratchet or force bar (not shown) as is known.

### Operation

With reference to FIG. 1, the assembly of the adjustable socket 100 conveniently proceeds by dropping both of the jaws 102 into the inverted housing 101 and positioning them in their open position as best seen in FIGS. 3A and 3B. The traveling balls 113 are then each inserted through radial holes 110 and into longitudinal holes 142 where they fall under the influence of gravity until they reach the horizontal inside surface 143 of housing 101 as best seen in FIG. 3A. Adjustment shaft 104 is then inserted into radial hole 111 in housing 101 and adjusting wheel 103 is inserted through its complementary opening 144 in housing 101 and has its center hole 150 manually aligned with the adjustment shaft 104 which is pushed through the center hole 150 of adjusting wheel 103 and into the oppositely located radial hole 111 (FIG. 3A) in housing 101. Retaining pin 121 is then inserted into the receiving hole 151 of the adjusting wheel 103 and is pushed through the receiving hole 152 in adjustment shaft 104.

The housing 101 and its assembled components are then again inverted back to their normal position and the balls 113 previously inserted into holes 142 will move under gravity into contact with the adjustment shaft 104. Adjustment shaft 104 is rotated by way of adjusting wheel 103 until the balls 113 enter the left and right hand grooves 112 respectively. The retaining pins 114 are each inserted into the jaws 102 by way of holes 120 and the balls 113 are then held in place in contact with the grooves 112 as best seen in FIG. 3A.

In the event the detent mechanism 105 is incorporated in the adjustable tool 100, ball 123 is inserted into hole 124 in housing 101 and is followed by the insertion of spring 125 and set screw 130 to hold the ball 123 and spring 125 in their operating position with ball 123 being forced against the facing surface of adjusting wheel 103. When the adjusting wheel 103 is rotated, the ball 123 will enter one of the various recesses 122 which serve an indexing function for the adjusting wheel 103 and jaws 102.

In operation following assembly, the jaws 102 are then adjusted by way of manual rotation of the adjusting wheel 103 to fit, for example, a bolt 134 shown in phantom in FIG. 3C. The adjustment shaft 104, due to the grooves 112 and balls 113 moving relative thereto, will allow jaw adjustment from the fully open to the fully closed positions, in less than a single revolution of the adjustment wheel 103.

When the bolt 134 is tightly grasped by the jaws 102, the adjustable tool 100 is rotated by the insertion of the square drive of a ratchet or force bar (not illustrated) into the female and complementary cavity 154 (FIG. 2B) as desired to remove or to install the fastener or bolt 134.

As the adjusting tool 100 is rotated under the influence of the ratchet or force bar, the flats 160 of the jaws 102 will contact with the inside surfaces 153 of the housing 101. This allows the torque acting on the jaws 102 during rotation of the fastener 134 to be transferred to the housing 101. This is useful since the integrity of the jaws 102 which are grasping the fastener 134 is maintained because of the lower forces absorbed by the jaws 102. It further allows an increased torque to be applied to the fastener 134 during fastener rotation. The use of the grooves 112 and balls 113 further allows for considerably less play between the jaws 102 as opposed to a screw with a helical flight formed around the screw.

Many modifications will readily occur to those skilled in the art to which the invention relates. For example, the ball detent mechanism described as comprising ball 123, spring 125 and set screw 130 may be simply deleted with the adjusting wheel 103 being rotated without the various detent positions. Alternatively, the detent mechanism can remain but the recesses 122 in the face of the adjusting wheel can be deleted. This might be useful, for example, where it is desired to make a finer adjustment for closing or opening the jaws 102 than would be provided by subsequent recesses 122. The adjustment shaft 104 and its associated hardware could likewise be replaced with alternative mechanisms for moving the jaws 102, such as a wedge type mechanism with a V-groove and a wedge for a follower and it is intended that the term “adjustment shaft” cover those additional mechanisms when used in association with the housing 101. A locking mechanism for the adjusting wheel 103 could be provided to securely hold the jaws 102 in position once the desired position of the jaws 102 is obtained. Further, the insertion of the balls 113 and the retaining pins 114 could take place in the jaws 102 a different manner from that described; that is, the balls 113 could be inserted into holes drilled in the bottom of the jaws 102 rather than in the top portion as is described. And an alignment mechanism for the jaws 102 additional to the adjustment shaft 104 could be provided such as a horizontal shaft which extends through the jaws 102 in a position separate from that of the axis of holes 110. This could likewise provide improved tool integrity during operation.

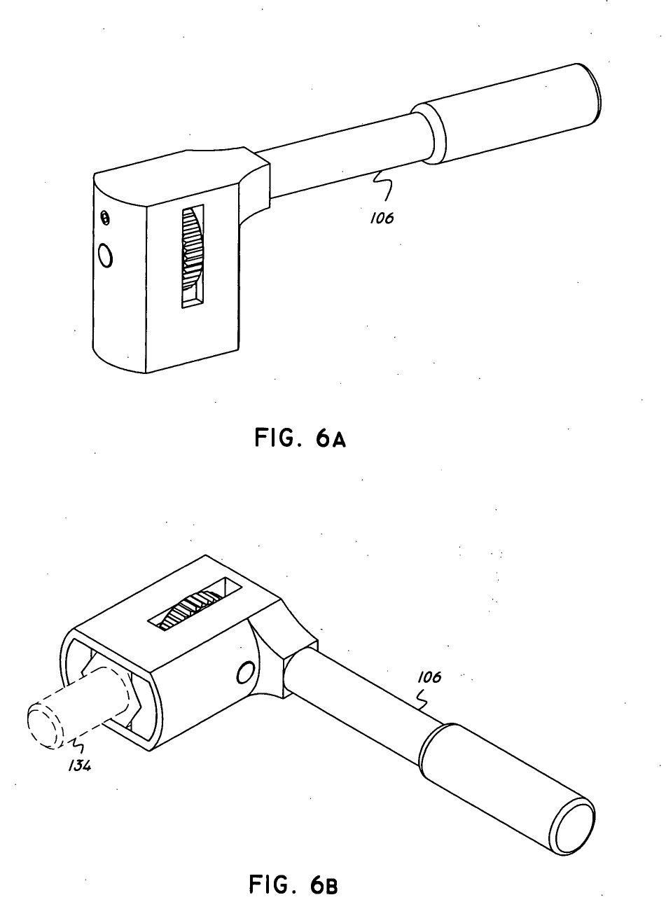

While the adjusting tool 100 is described in association with adjustable jaws 102 which grasp the outside of a fastener, it is apparent that the jaws 102 could instead grasp the inside of a cavity within the fastener. The jaws could then take the form, for example, of an adjustable allen wrench. Likewise, while the adjusting tool 100 is described as being separate from a ratchet or force bar 106, the latter being illustrated in FIGS. 6A and 6B, it is apparent it could also be a unitary tool which incorporates a ratchet or force bar 106 as illustrated in FIGS. 6A and 6B as part of the tool itself. While the adjusting wheel 103 is described as being manually adjusted by a user, such adjustment is contemplated to also be accomplished by way of an actuator which could rotate the adjusting wheel 103 or adjustment shaft 104 under the influence of pneumatic, electric or hydraulic power as desired by the user. This would be useful, for example, when the tool 100 is used in an automatic assembly operation where the tool 100 needs to be opened and closed more rapidly than under the normally contemplated uses of intermittent fastener removal and installation. Further, while the housing 101 is described as being a single member, it would of course be possible to make the housing 101 in two (2) or more segments which are subsequently welded or otherwise joined together and it is intended to cover these additional modifications to the housing in the term “integral member”.

While it is contemplated that a pair of jaws are provided and that this pair moves simultaneously under the influence of the adjustment shaft 104 and adjusting wheel 103, it is clear that only one jaw might move while the adjustment process occurs with the remaining jaw being stationary. The stationary jaw could also be formed as part of the inside of the housing 101.

Many further modifications will readily occur to those skilled in the art to which the invention relates and the specific embodiments described herein should be taken as illustrative of the invention only and not as limiting its scope as defined in accordance with the accompanying claims.

I claim:

1. An adjustable tool used to grasp and loosen or tighten a fastener, said tool comprising a set of jaws, at least one of said jaws being movable on an axis transverse to said axis of said fastener to be tightened or loosened, said jaws defining an opening ranging between fully open and fully closed positions, said movable jaw being located within a housing adjacent to and surrounding the periphery of said jaw, said housing being an integral member and said movable jaw being movable by an adjustment mechanism, said movable jaw operably contacting said housing in a force transfer relationship during said fastener loosening or fastener tightening operation.

2. An adjustable tool as in claim 1 wherein said movable jaws number two.

3. An adjustable tool as in claim 2 wherein said adjustment mechanism comprises a rotatable adjusting wheel and a shaft rotatable by said adjusting wheel, said shaft being operably connected to said jaws, said shaft adjusting the opening of said jaws between said fully open and fully closed positions.

4. An adjustable tool as in claim 3 wherein said shaft has at least one groove formed therein, and further comprising a follower operably connected to said jaws, said follower operably allowing the opening and closing of said jaws as said shaft is rotated by said adjusting wheel.

5. An adjustable tool as in claim 4 wherein said follower is a ball operably positioned within said jaws and moving in said groove as said groove moves with rotation of said shaft during said movement of said adjusting wheel.

6. An adjustable tool as in claim 5 wherein said adjusting wheel includes a detent mechanism to maintain said adjusting wheel in one of a plurality of positions.

7. An adjustable tool as in claim 6 wherein said detent mechanism is a spring mounted ball operably mounted in said housing, said spring mounted ball acting on a respective one of a plurality of recesses within said adjusting wheel as said adjusting wheel is rotated.

8. An adjustable tool as in claim 7 wherein said adjusting wheel rotates less than one turn to move said jaws between said fully open and said fully closed positions.

9. An adjustable tool as in claim 1 wherein said jaws grasp said fastener on the outside of the head of said fastener.

10. An adjustable tool as in claim 1 wherein said jaws grasp said fastener on the inside of a recess in the head of said fastener.

11. An adjustable tool as in claim 1 wherein said adjustable tool is in the form of a socket.

12. An adjustable tool as in claim 1 and further including a handle used to rotate said housing.

13. An adjustable tool as in claim 1 wherein said housing is an integral member comprising at least two segments joined together in a rigid relationship under operating conditions.

14. An adjustable tool as in claim 1 wherein said jaws grasp said fastener within said housing, said movable jaw being substantially wholly within said housing during said movement.

15. An adjustable tool having a set of jaws operable to grasp a fastener to be removed or installed, said tool having at least one movable jaw within said housing and mounted on a shaft radial to the axis of said fastener, said jaw being positioned within said housing, and an adjusting wheel accessible by a user and being connected to said shaft, said shaft having at least one groove formed therein and at least one ball within said groove which ball is rotatable within said groove.

16. A method of loosening or tightening a fastener using a set of adjustable jaws, at least one of said jaws being movable within a housing, said method comprising forming an opening between said jaws to operably allow the grasping of said fastener, applying a torque to said jaws to rotate said fastener and transferring a substantial portion of said torque from said jaws to said housing while loosening or tightening said fastener.

17. Method as in claim 16 wherein said movable jaws number two.

18. A method as in claim 16 wherein said at least one movable jaw moves under the influence of an adjusting wheel rotatable by a user and operably connected to a shaft extending through said at least one movable jaw, said shaft including a follower operably positioned within said movable jaw.

19. A method as in claim 18 wherein said shaft includes at least one groove and said follower is a ball operably located within said groove, said groove and said ball having relative movement therebetween to allow movement of said movable jaw relative to said shaft and said fastener.

20. Method as in claim 16 wherein said movable jaw contacts said housing during said rotation of said fastener.

21. Method as in claim 20 wherein said adjusting wheel is moved between a plurality of positions, each of said positions being defined by a detent mechanism acting on said adjusting wheel.

22. Method as in claim 21 wherein said adjusting wheel moves less than one revolution when said opening of said jaws changes from said fully open to said fully closed positions.

23. Method as in claim 16 wherein said jaws grasp said fastener within said housing, said movable jaw moving wholly within said housing during said movement.

24. A method of loosening or tightening a fastener using a set of adjustable jaws, at least one of said jaws being movable within a housing, said method comprising forming an opening between said jaws to operably allow the grasping of said fastener by rotating a shaft with a groove formed therein and a ball rotatable within said groove, said rotation of said shaft adjusting said opening of said jaws.

25. Method as in claim 24 wherein said movable jaws number two.

26. Method as in claim 25 wherein said shaft is rotatable by an adjusting wheel, said shaft being operably connected to said jaws, said shaft adjusting the opening of said jaws between larger or smaller distances.

27. Method as in claim 26 wherein said adjusting wheel includes a detent mechanism to maintain said adjusting wheel in one of a plurality of positions.

28. Method as in claim 27 wherein said detent mechanism is a spring mounted ball operably mounted in said housing and acting on a respective one of a plurality of recesses on said adjusting wheel as said adjusting wheel is rotated.

29. Method as in claim 28 wherein said shaft rotates less than one revolution to move said jaws between fully open and fully closed positions.

30. Method as in claim 29 wherein a torque is applied through said jaws to said fastener and a substantial portion of said torque is transferred from said jaws to a housing, said jaws remaining substantially within said housing during movement of said jaws and said application of said torque to said fastener.
